(19) United States
(12) Patent Application Publication
(10) Pub. No.: US 2023/0315805 A1
(43) Pub. Date: Oct. 5, 2023

(54) METHOD FOR EXECUTING ONE OR MORE VECTOR MATRIX OPERATIONS, COMPUTING UNIT AND COMPUTING MODULE FOR EXECUTING SAME

(71) Applicant: Robert Bosch GmbH, Stutgart (DE)

(72) Inventors: Taha Ibrahim Ibrahim Soliman, Renningen (DE); Tobias Kirchner, Ludwigsburg (DE)

(21) Appl. No.: 18/041,185

(22) PCT Filed: Jul. 30, 2021
(86) PCT No.: PCT/EP2021/071434

§ 371 Date: Feb. 9, 2023

(30) Foreign Application Priority Data
Aug. 12, 2020 (DE) 10 2020 210 191.4

(51) Int. Cl. G06F 17/16

(52) U.S. Cl. CPC G06F 17/16

(57) ABSTRACT

A method for executing one or multiple vector matrix operations using a matrix operation circuit. The method includes: receiving an input vector having a plurality of input values; applying and increasing row voltages on row lines of the matrix, wherein the row voltages are increased linearly starting from zero, and for each of the row voltages, a rate of increase is proportional to one of the input values; detecting the output currents generated at the current outputs; comparing current intensities of the detected output currents to a predetermined limit current intensity; terminating the increase of the row voltages, if, upon comparison, it is established that at least one of the output currents has a current intensity which is greater than the limit current intensity; and determining one or multiple output vectors having a plurality of output values on the basis of the measured currents.

### FIELD

The present invention relates to a method for executing one or more vector matrix operations, as well as to a computing unit and a computing module for executing same.

### BACKGROUND INFORMATION

In many computationally intensive tasks, in particular in artificial intelligence applications or in machine learning applications, a processing of vectors using matrix operations is necessary. For example, vector matrix multiplications must be executed. In order to execute such matrix operations quickly and efficiently, vector matrix multipliers in the form of dedicated electronic circuits may be used.

In these vector matrix multipliers, which are also referred to as “dot-product engines”, a vector of input voltages is converted into a vector of output voltages by means of a matrix-like array of memristors, arranged at intersection points of orthogonal lines and connecting the crossing lines in pairs, wherein the output voltages are each proportional to the dot product of the vector of the input voltages with the conductivities of the memristors arranged in a column. In this case, the input voltages are applied to the row lines running in one direction and lead to currents via the memristors into the column lines that run orthogonally thereto and whose potential is at ground potential. Using transimpedance amplifiers, the currents can be converted into the output voltages, which are converted into corresponding digital values by analog-digital converters. Such circuitry can reach sizes of a few 100 rows and columns, respectively.

### SUMMARY

According to the present invention, a method for executing one or more vector matrix operations as well as a computing unit and a computing module for executing said method with the features of the present invention is provided. Advantageous configurations and example embodiments are disclosed herein.

According to the an example embodiment of the present invention, the row voltages of the matrix operation circuit are increased in a proportional manner to input values forming an input vector and associated output currents are detected at the current outputs of the columns, wherein this increase is performed only until at least one of the output currents of the matrix operation circuit reaches a limit current intensity. The output values forming an output vector are determined based on the detected output currents. This makes it possible, on the one hand, to limit the electrical currents through the column lines and, on the other hand, to improve the signal-to-noise ratio by selecting a suitable limit current intensity by a higher limit current intensity, or to reduce the energy consumption by a lower limit current intensity.

Based on the detected output currents, one or more output vectors can be determined, wherein various preferred determination methods can be executed and/or multiple passes of the method can be executed to determine several output vectors (to an input vector). The mapping of the input vector onto an output vector by means of the matrix operation circuit represents a vector matrix operation.

According to an example embodiment of the present invention, preferably, the output values of an output vector are determined as the current intensities of the output currents at termination. This operation is easy to execute because it does not require any further calculations. It leads to non-normalized output vectors and is particularly expedient if only the relative size of the entries of the output vectors is of interest.

Preferably, the output values of an output vector are determined as quotients of the current intensities of the output currents at termination and the limit current intensity. By dividing the current intensities by the limit current intensity, a normalization is performed so that normalized output vectors are obtained that can be compared to other normalized output vectors obtained in other passes of the method (with different limit current intensity and/or other input values). This is particularly expedient if the matrix operation circuit implements a linear matrix mapping.

Preferably, according to an example embodiment of the present invention, the method comprises integrating the detected currents over the period of increasing the row voltages until termination in order to obtain integrated current intensities, wherein the output values of an output vector are determined as the integrated current intensities. Likewise, preferably, the method comprises integrating the detected current intensities over the period of increasing the row voltages until termination in order to obtain integrated current intensities, wherein the output values of an output vector are determined as quotients of the integrated current intensities and the limit current intensity. By integrating the currents or current intensities, a better signal-to-noise ratio can be achieved. If the integrated current intensities are additionally divided by the limit current intensity, normalized output vectors are obtained that allow for a comparison of different passes of the method. It is also possible here to determine output vectors based on non-integrated current intensities as well as based on integrated current intensities (respectively normalized or non-normalized); a comparison of the two output vectors thus determined (or the spreads of the entries of the output vectors) allows for a statement about the signal-to-noise ratio of the matrix operation circuit at the selected limit current intensity.

Preferably, according to an example embodiment of the present invention, the method further comprises measuring an energy consumption of the matrix operation circuit during the method steps from the application of the row voltages until the termination of increasing the row voltages; if the energy consumption is above a predetermined target range for the energy consumption, decreasing the limit current intensity; or if the energy consumption is below the predetermined target range for the energy consumption, increasing the limit current intensity; and repeating the method steps.

The decreasing or increasing of the limit current intensity can proceed either by a certain percentage of the limit current intensity, e.g., by 20%, 10%, or 5%, or as a function of the ratio of the predetermined target energy consumption to the measured energy consumption. Preferably, the limit current intensity is changed according to the formula

$${I}_{G , n e w} = \sqrt[3]{{W}_{Z} / {W}_{M}} ⋅ {I}_{G , o l d} ,$$

where I_{G},_{new} is the new, changed limit current intensity, I_{G},_{old} is the old, unchanged limit current intensity, W_{z} is an energy consumption value in the target range (e.g., the mean value between upper and lower limit of the target range) for the energy consumption, and W_{M} is the measured energy consumption. Since in repeated matrix operation calculations within a particular neural network application, similar input values and weights of the matrix elements occur time and again, the energy consumption of these different matrix operation calculations will be within a specific range, such that this configuration of the method is able to keep the energy consumption and thus the thermal power output of the matrix operation circuit within a desired target range, so as to avoid overheating, for example.

Preferably, with the exception of the reception of the input values, the method steps are executed several times in several passes, the limit current intensity being respectively changed between the passes, and several sets of output values, namely, at least one set of output values in each pass, being determined. This allows for the dynamic range to be increased. This is helpful if the bandwidth of the output currents is greater than a measurement range of analog-digital converters used to measure the output currents, or if some of the output currents are very large relative to other, smaller output currents so that differences between the smaller output currents are not detected.

A computing unit according to the present invention is configured to execute all method steps of a method according to the present invention. A computing module according to the present invention comprises a computing unit according to the present invention and a vector matrix multiplier with memory cells arranged in matrix-like fashion in rows and columns.

Additional advantages and configurations of the present invention result from the description and the figures.

The present invention is illustrated schematically in the figures on the basis of embodiment examples and is described below with reference to the figures.

### BRIEF DESCRIPTION OF THE DRAWINGS

FIGS. 1A and 1B show a vector matrix multiplier.

FIG. 2 shows a matrix operation circuit and illustrates the row voltages applied thereto in accordance with an example embodiment of the present invention and the measured output currents.

FIG. 3 shows a method according to the present invention according to a preferred embodiment of the present invention.

FIG. 4 shows a method according to the present invention according to a further preferred embodiment of the present invention.

FIG. 5 shows a computing module according to a preferred embodiment of the present invention.

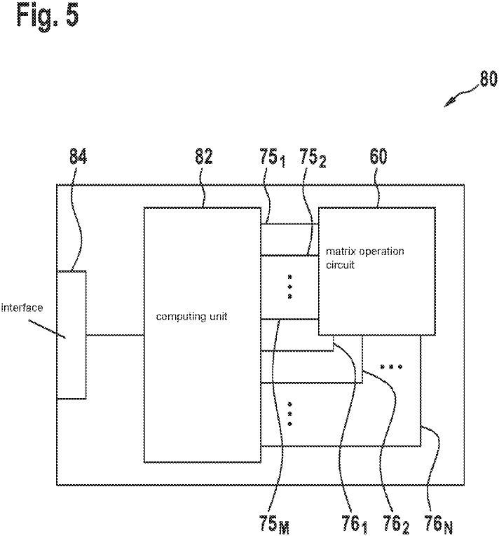

### DETAILED DESCRIPTION OF EXAMPLE EMBODIMENTS

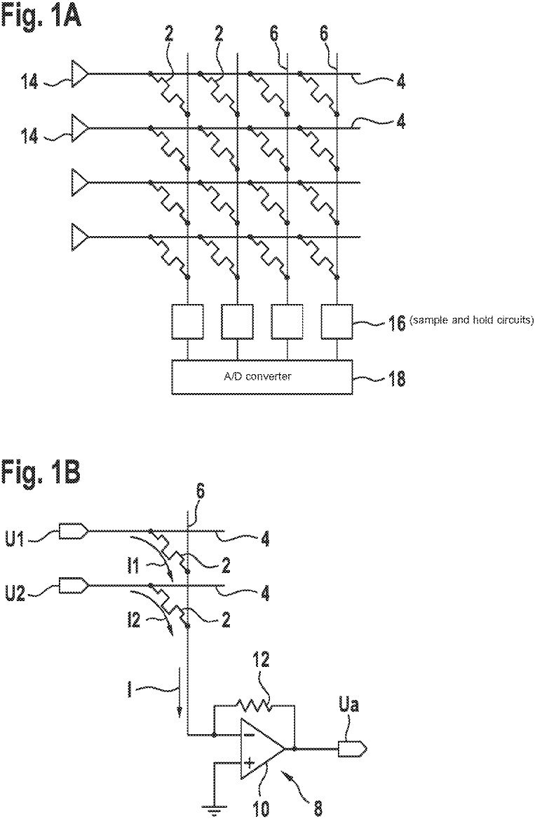

FIGS. 1A and 1B depict a vector matrix multiplier and a matrix operation circuit, also referred to as a “dot product engine”, respectively, which can be employed for the method according to the present invention. The vector matrix multiplier comprises memory cells, in the form of memristors 2, arranged in matrix-like fashion in rows and columns. The number of rows and the number of columns are arbitrary, a 4×4-layout being shown by way of example. The memory function of the memristors results from the fact that the resistance of the memristors is adjustable by applying a programming voltage.

The vector matrix multiplier further comprises a row line 4 for each line of the matrix-like arrangement, and a column line 6 for each column (only a few elements are marked with reference characters for clarity). The memristors 2 are arranged at the intersection points of the row and column lines that run perpendicular to each other and in each case connect a row of lines with a column line, which are otherwise not connected.

If voltages are applied to the row lines, currents flow from the row lines 4 through the memristors 2 into the column lines 6. This is illustrated for one column and two rows in FIG. 1B. There, a voltage U1 is applied to one of the row lines and a voltage U2 is applied to the other. The current I1 through one of the memristors is determined by its conductivity G1: I1 = G1 • U1; the current I2 through the other memristor, whose conductivity is G2, is I2 = G2 • U2, respectively. The sum of the currents, i.e. the total current I = I1 + I2 = G1 • U1 + G2 • U2, then flows through the column line 6. Thus, there is a multiplication of the voltages U1, U2 considered as a vector on the row lines 4 with the conductivities G1, G2, considered as a vector, of the memristors in a column, the total current being proportional to the result of this vector product. With respect to the matrix arrangement as a whole, there thus essentially occurs a multiplication of the vector of the voltages with the conductivities of the memristors considered as matrix elements.

The total current of each column is typically converted into an output voltage Ua by means of a transimpedance amplifier 8. The conventional transimpedance amplifier 8, which is shown here by way of example, comprises an operational amplifier 10 whose inverting input is connected to the column line and whose non-inverting input is connected to ground, and a resistor 12 over which the operational amplifier is counter-coupled such that the output voltage Ua is proportional to R • I, where R is the resistance value of resistor 12. The transimpedance amplifier 8 provides at its input (inverting input of the operational amplifier 10) a (virtual) ground that is required for the function described above.

The voltages on the row lines are typically generated from digital signals using digital-to-analog converters 14. The output voltages are typically converted back into a digital signal on the column lines by means of sample-and-hold circuits 16 and an analog-digital converter 18.

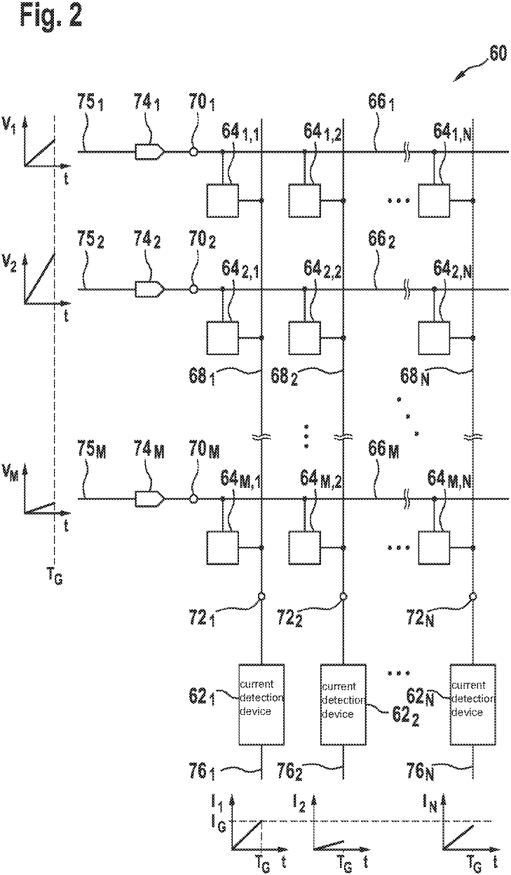

FIG. 2, similar to FIG. 1A, shows a matrix operation circuit that can be used in the implementation of the present invention, the general case of a matrix operation circuit 60 with M lines and N columns being illustrated here. The matrix operation circuit 60 has several memory elements 64_{1.1}, 64_{1.2,} ... 64_{1.N′} 64_{2.1}, 64 ₂.₂, ... 64_{2.N}, ... 64_{N.1′} 64_{N.2′} ... 64_{M},_{N} arranged in a matrix-like manner in rows (number M) and columns (number N). A row line 66₁, 66₂, ... 66_{M} is provided for each row, and a column line 68₁, 68₂, ... 68_{N} is provided for each column. The memory elements are respectively connected to a row line and to a column line. Each memory element has a memory state (e.g., in the form of a conductance value as described in connection with FIG. 1A) and is configured to generate, in the column line to which it is connected, a current that depends on the memory state and the voltage applied on the row line to which the memory element is connected. In total, at current outputs 72₁, 72₂, ... 72_{N} of the column lines, currents are thus generated, which are dependent on multiple voltages (line voltages) applied on voltage inputs 70₁, 70₂, ... 70_{M} of the row lines. The plurality of row voltages on the voltage inputs may be regarded as input voltage vector or vector of input voltages. The plurality of output currents on the current outputs may be regarded as output current vector or vector of output currents. The output currents are detected or measured by current detection devices 62₁, 62₂, ... 62_{N}, which can comprise, for example, transimpedance amplifiers, as shown in FIG. 1B.

The memory states of the memory elements approximately correspond to matrix entries by which the mapping of the row voltages to output currents realized by the matrix operation circuit is determined. The memory elements can be formed, for example, by memristors as described in connection with FIGS. 1A, 1B; the memory state is then determined by the conductance value of the memristors. However, other embodiments are also possible, e.g., the memory elements can each comprise, in addition to the memristors, a semiconductor switching element (for instance a field effect transistor) with which the respective memristor can be selectively controlled. In this case, further control lines are provided for the semiconductor switching elements. More generally, additional lines necessary for the respective implementation of the memory elements can be provided.

The matrix operation circuit 60 can further include, for each line, a digital-to-analog converter 74₁, 74₂, ... 74_{M}, whose outputs are each connected to a row line or to a voltage input 70₁, 70₂, ... 70_{M} and whose inputs form the inputs 75₁, 75₂, ... 75_{M} of the matrix operation circuit 60. The digital-analog converters are used to generate, from input values or input vectors present in digital form, e.g. a vector of M numerical values, corresponding row voltages that can be applied to the row lines. Digital-analog converters can also be omitted if the input vectors are present in analog form as voltages (e.g., if a corresponding control circuit generates such); the inputs of the matrix operation circuit are then formed by the voltage inputs.

The current detection devices or current measuring devices 62₁, 62₂, ... 62_{N} are each connected to a column line, i.e. an input of each of the current detection device 62₁, 62₂, ... 62_{N} is connected with a corresponding current output 72₁, 72₂, ... 72_{N} of the respective column line. Preferably, the current detection devices provide a ground potential or a (virtual) ground at their respective input. The detected currents or their current intensities are provided at or can be read out at outputs of the current detection devices; these outputs form the outputs 76₁, 76₂, ... 76_{N} of the matrix operation circuit 60. The current detection devices can in particular be formed by transimpedance amplifiers, as described in connection with FIG. 1B, indicated there by reference numeral 8. In addition, an analog-digital converter can be respectively provided, which converts the analog output signal (Ua in FIG. 1B) into a corresponding digital value.

FIG. 2 further illustrates the principle of operation of the present invention. Via voltage terminals 70₁, 70₂, ... 70_{M} or the inputs 75₁, 75₂, ... 75_{M} of the digital-analog converter 74₁, 74₂, ... 74_{M}, voltages V₁, V₂, ... V_{M} are applied to row lines 66₁, 66₂, ... 66_{M}, which rise or are increased over time. This is illustrated in voltage-time diagrams on the left side of the figure, where V₁, V₂, ... V_{M} denotes the respective row voltage axis and t denotes the time axis. The row voltage curve can be generated by a control circuit (not shown), which provides or generates the digital or analog row voltage values in rising form. Through the matrix circuit 60, output currents I₁, I₂,... I_{N} are generated, on the basis of the row voltages, at current outputs 72₁, 72₂, ... 72_{N} of column lines 68₁, 68₂, ... 68_{N}, which are detected by current measuring devices 62₁, 62₂, ... 62_{N}. The curve of the output currents is illustrated in current-time diagrams at the bottom of the figure, where t again denotes the time axis and I₁, I₂, ... I_{N} denotes the current intensity axis of the output currents. Once the current intensity of one of the output currents reaches the limit current intensity I_{G}, which is drawn by a dashed line, the increasing of the input voltages V₁, V₂, ... V_{M} is ended. In the figure, this is illustrated by the example of current intensity I₁ . The corresponding point in time is indicated in the diagrams with T_{G}, respectively.

In order to detect whether one of the current intensities exceeds the limit current intensity, the measured current intensities can be converted into digital current intensity values and compared, e.g. by a control circuit, to a likewise digital value of the limit current intensity. Alternatively or additionally, a comparison circuit can also be provided, which comprises, for example, comparators that compare the output voltages of the current detection devices (for instance the voltage Ua of the transimpedance amplifier of FIG. 1B), prior to their conversion into digital current intensity values, with a comparison voltage (corresponding to the limit current intensity) and generate a signal when this comparison voltage is exceeded.

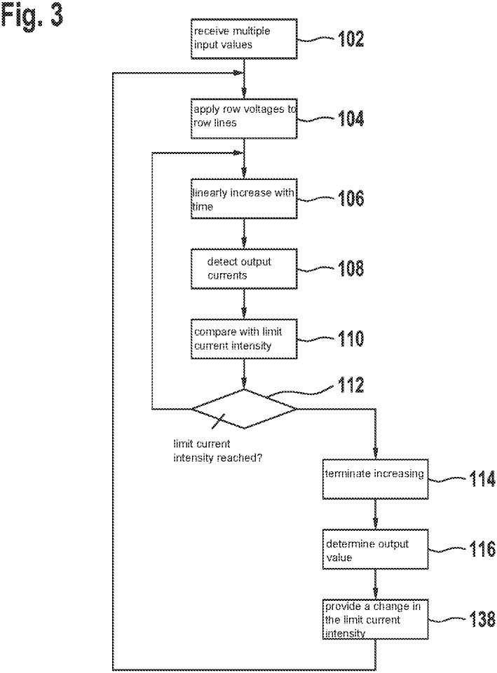

FIG. 3 shows a flow chart of the method according to a preferred embodiment of the present invention. First, in step 102, multiple input values are received, which can be considered as entries of an input vector that is to be processed by the matrix operation circuit. Here, each of the input values, i.e. each of the input vector entries, is associated with a row or a row line. In principle, it is possible that fewer input values are received than the number of row lines of the matrix operation circuit. In that case, no voltage is applied to the “excess” row lines, or it is possible to think of respective additional entries of the input vector as being filled with zero.

In step 104, row voltages are applied to the row lines, the row voltages first being at zero and then starting from this being linearly increased with time in step 106. For each of the row voltages Vᵢ, the rate of increase ΔVᵢ/Δt is proportional to the input value eᵢ, which is assigned to the i-th row line, wherein the proportionality constant _{K} is common to, or identical for, all row voltages, i.e. Vᵢ = _{K} · eᵢ ·t if t is time. The proportionality constant _{K}, in addition to the limit current intensity and the properties of the matrix operation circuit, determines the speed of the method.

In step 108, the output currents are detected at the current outputs of the matrix circuit. In particular, their current intensities Ij, which are a function of time t, i.e. Iⱼ = Iⱼ(t), are also measured and compared in step 110 with the limit current intensity I_{G}. Thereupon, in step 112, based on the result of this comparison, the method either proceeds with step 106 (increasing the row voltages), if the limit current intensity was not reached or exceeded by any of the output currents, or, if at least one of the output currents reaches or exceeds the limit current intensity, to the method proceeds with step 114, in which increasing the row voltages is terminated at a corresponding time T_{G}.

In step 116, based on the detected output currents Iⱼ(t), an output value aⱼ is determined for each column or for each current output, which output values can be regarded as entries of an output vector (a₁, a₂, ... a_{N}) . It is also possible to determine several output values for each column and accordingly to determine several output vectors. The determination of the output values can be based on the current intensities at the termination of the row voltage increase, i.e. aⱼ = Iⱼ(T_{G}), or also on integrated current intensities, i.e. aⱼ = ∫Iⱼ(t) dt, which have been integrated over time from the start to the termination of the row voltage increase. Furthermore, a normalization by quotient formation with the limit current intensity, i.e. by dividing by the limit current intensity, is also possible, i.e. aⱼ = Iⱼ(T_{G}) / I_{G} or aⱼ =1/I_{G} · ∫Iⱼ (t) dt. Advantages of these determination options were explained above. For the output values, especially the numerical value is of interest, i.e. the corresponding units (ampere, coulomb, seconds) can be neglected, which of course should be done in a consistent manner (e.g., within an output vector, the values must be based on the same unit; or, a comparison of magnitudes of entries of two output vectors must be based on the same unit).

In the optional step 138, a change in the limit current intensity is provided, wherein the method subsequently returns to step 104 (applying the row voltages) and the method is repeated from this starting point. As a result, one or more additional output vectors can be determined based on the same input vector, which supplement the already determined output vectors. This is expedient, for example, if analog-digital converters used in the current intensity detection only have a limited dynamic range or measuring range, such that, for example, in a first pass of the method, smaller output currents all fall to the lower limit of the measuring range and thus cannot be differentiated. Here, the limit current intensity can then be changed (increased) for a further pass of the method so that these smaller output currents are distinguishable, but large output currents are at or above the upper limit of the measurement range (in the saturation range). A new combined vector can then be formed from the two output vectors, in that the respective suitable output values of the two output vectors are used. For this purpose, the output vectors are advantageously normalized by dividing by the respective limit current intensity. Preferably, the new limit current intensity is a fraction, further preferably less than or equal to ½, in particular ½, ¼ or ⅛, or a multiple, further preferably greater than twice the old limit current intensity, in particular 2, 4 or 8 times the old limit current intensity.

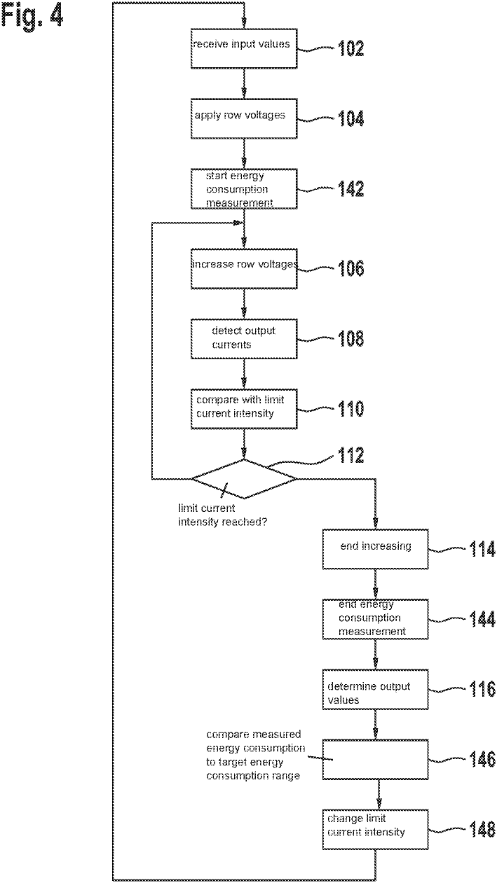

FIG. 4 shows a flow chart of the method according to a further preferred embodiment of the present invention. This essentially corresponds in part to the embodiment of FIG. 3, so that identical method steps are provided with the same reference symbol on the one hand and on the other hand are not described again; rather reference is made to the associated description in the context of FIG. 3. These are in detail the steps 102 (receiving the input values, 104 (applying the row voltages), 106 (increasing the row voltages), 108 (detecting the output currents), 110 (comparing with limit current intensity), 112 (checking whether limit current intensity is reached), 114 (ending the increasing of the row voltages), 116 (determining the output values).

Additionally, in this embodiment, an energy consumption measurement is is performed, i.e., the energy consumed by the matrix operation circuit is measured by a suitable measuring device. To this end, the energy consumption measurement is started in step 142. This step 142 can be executed before, at the same time as or, as in the figure, after applying the row voltages (Step 104); in any case, this step should be executed prior to increasing the row voltages (Step 106). After the limit current intensity has been exceeded and the increasing of the row voltages has been terminated (Step 114), the energy consumption measurement is ended in step 144, i.e., in total the energy required by the matrix operation circuit to execute the matrix operation is determined.

In step 146, the measured energy consumption is compared to a target energy consumption range (or target range for the energy consumption) and, in step 148 (corresponding approximately to step 138 of the embodiment of FIG. 3), the limit current intensity is changed based on this comparison, i.e., if the measured energy consumption is greater than the target energy consumption range, the limit current intensity is decreased, and if the measured energy consumption is less than the target energy consumption range, the limit current intensity is increased. Subsequently, the method returns to step 102, receiving input values, wherein new input values are received. This can be helpful if, when using the method in an application in the field of neural networks, the matrix operations in each case cause a similar, typical energy consumption in a matrix operation, such that by such energy consumption control the power consumption of the circuit can be kept within certain limits, to avoid overheating, for example, and at the same time to ensure the highest possible accuracy or to ensure the lowest possible signal-to-noise ratio. The target energy consumption range can be indicated as a mean value W_{M} of the target energy consumption range plus/minus a certain percentage of the mean value, e.g. from

$${\text{W}}_{\text{M}} {\text{- 20\% to W}}_{\text{M}} {\text{+ 20\% or from W}}_{\text{M}} {\text{- 10\% to W}}_{\text{M}} \text{+ 10\%} \text{.}$$

It is also possible (alternatively or in addition to changing the limit current intensity in step 138 of FIG. 3 or step 148 of FIG. 4), to change the proportionality constant _{K}.

Thus, the method can be accelerated (increase of the proportionality constant) or slowed (decrease of the proportionality constant). In particular, in combination with controlling the energy consumption according to the target energy consumption range, the power output can thus be controlled.

FIG. 6 shows a computing module according to the present invention, which can be used in carrying out the method. The computation module 80 can be considered a neural network computation module, i.e., a computation module for executing and accelerating matrix calculations in the context of neural network or artificial intelligence applications. The computing module 80 comprises a matrix operation circuit 60 according to the present invention, such as shown in FIG. 2. Further, the computing module comprises a computing unit 82 configured to execute a method according to the present invention, such as one of the methods described in connection with FIGS. 3 and 4. The computing unit forms a control circuit for controlling the matrix operation circuit 60. For example, the computing unit can comprise a processor core and/or a field programmable gate array (FPGA) and associated memory. The computing unit can also be realized in the form of several modules.

The computing unit 82 is connected via corresponding lines with the inputs 75₁, 75₂, ... 75_{M} of the matrix operation circuit 60 and with the outputs 76₁, 76₂, ... 76_{N} of the matrix operation circuit 60. On the one hand, the row voltages (digital or analog) are transmitted to the matrix operation circuit via these lines and, on the other hand, the output currents are read out, wherein the computing unit 82 is in particular configured, according to the method according to the present invention, to generate the increases of the row voltages (digital or analog), to detect the output currents (which are communicated by the current detection devices) and to determine the output values (based on the detected output currents).

Further, the computing module 80 includes an interface 84 connected to the computing unit 80 and used for external communication. The interface can be designed as a parallel or serial interface, e.g., USB (Universal Serial Bus), PCI (Peripheral Component Interconnect), PCI Express or other conventional interfaces; an interface for wireless communication is also possible. The computing module can be accessed via interface 85, e.g., from a computer connected to the computing module via the interface. Of course, the computing module can comprise further units and lines (not shown) that are used particularly for programming the memory elements of the matrix operation circuit comprised in the summation circuit 60. A programming unit (not shown), which controls corresponding programming lines (which may be partially identical to the row and column lines), can be included in the computing unit 82 or, at least in part, can be realized as a separate unit on the computing module. In principle, it is also possible for the summation circuit 60 to be integrated in a plug-in module that can be plugged into a corresponding socket on the computing module. Programming of the memory elements can then be performed in a separate programming device independent of the computing module.

1-9. (canceled)

10. A method for executing one or multiple vector matrix operations using a matrix operation circuit, the matrix operation circuit including a plurality of row lines and a plurality of column lines, wherein the column lines each has a current output, the matrix operation circuit being configured to generate output currents at the current outputs, current intensities of the output currents being a function of multiple row voltages applied on the plurality of column lines, the method comprising the following steps:
receiving an input vector having multiple input values;
applying and increasing the row voltages on the row lines, wherein the row voltages are increased linearly starting from zero, wherein, for each of the row voltages, a respective rate of increase is proportional to one of the input values in accordance with a proportionality constant, wherein the proportionality constant is common to all of the row voltages;
detecting the output currents generated at the current outputs;
comparing current intensities of the detected output currents to a predetermined limit current intensity;
terminating the increase of the row voltages when, upon comparison, it is established that at least one of the output currents has a current intensity that is greater than the limit current intensity; and
determining one or multiple output vectors each having multiple output values based on the detected currents.

11. The method according to claim 10, wherein the output values of the one or of one of the plurality of output vectors are determined as the current intensities of the output currents upon termination.

12. The method according to claim 10, wherein the output values of the one or of one of the plurality of output vectors are determined as quotients of the current intensities of the output currents upon termination and the limit current intensity.

13. The method according to claim 10, further comprising:
integrating the measured currents over a period of the increasing the row voltages until the termination of increasing the row voltages to obtain integrated current intensities;
wherein the output values of the one or of one of the plurality of output vectors are determined as the integrated current intensities.

14. The method according to claim 10, further comprising:
integrating the detected currents over a period of the increasing the row voltages until the termination of the increasing the row voltages to obtain integrated current intensities;
wherein the output values of the one or of one of the plurality of output vectors are determined as quotients of the integrated current intensities and the limit current intensity.

15. The method according to claim 10, further comprising the following steps:
measuring an energy consumption of the matrix operation circuit during the method steps from the applying and increasing the row voltages to the terminating the increase of the row voltages;
when the energy consumption is above a predetermined target range for the energy consumption, decreasing the limit current intensity, and when the energy consumption is below the predetermined target range for the energy consumption, increasing the limit current intensity; and
repeating the method steps.

16. The method according to claim 10, wherein the method steps are executed several times as passes with the exception of the receiving of the input values, wherein the limit current intensity is respectively changed between the passes, and wherein a plurality of sets of output values including at least one set of output values in each pass, is determined.

17. A computing unit configured to execute one or multiple vector matrix operations using a matrix operation circuit, the matrix operation circuit including a plurality of row lines and a plurality of column lines, wherein the column lines each has a current output, the matrix operation circuit being configured to generate output currents at the current outputs, current intensities of the output currents being a function of multiple row voltages applied on the plurality of column lines, the computing unit configured to:
receive an input vector having multiple input values;
apply and increase the row voltages on the row lines, wherein the row voltages are increased linearly starting from zero, wherein, for each of the row voltages, a respective rate of increase is proportional to one of the input values in accordance with a proportionality constant, wherein the proportionality constant is common to all of the row voltages;
detect the output currents generated at the current outputs;
compare current intensities of the detected output currents to a predetermined limit current intensity;
terminate the increase of the row voltages when, upon comparison, it is established that at least one of the output currents has a current intensity that is greater than the limit current intensity; and
determine one or multiple output vectors each having multiple output values based on the detected currents.

18. A computing module, comprising:
a matrix circuit including a plurality of row lines and a plurality of column lines, wherein the column lines each has a current output, the matrix operation circuit being configured to generate output currents at the current outputs, current intensities of the output currents being a function of multiple row voltages applied on the plurality of column lines; and
a computing unit configured to:
receive an input vector having multiple input values,
apply and increase the row voltages on the row lines, wherein the row voltages are increased linearly starting from zero, wherein, for each of the row voltages, a respective rate of increase is proportional to one of the input values in accordance with a proportionality constant, wherein the proportionality constant is common to all of the row voltages,
detect the output currents generated at the current outputs,
compare current intensities of the detected output currents to a predetermined limit current intensity,
terminate the increase of the row voltages when, upon comparison, it is established that at least one of the output currents has a current intensity that is greater than the limit current intensity, and
determine one or multiple output vectors each having multiple output values based on the detected currents.
